(19) United States
(12) Patent Application Publication
(10) Pub. No.: US 2022/0354087 A1
(43) Pub. Date: Nov. 10, 2022

(54) PET FOOD DISH

(71) Applicant: Lisa Breann Burke, Grapevine, TX (US)

(72) Inventor: Lisa Breann Burke, Grapevine, TX (US)

(21) Appl. No.: 17/737,542

(22) Filed: May 5, 2022

Related U.S. Application Data
(60) Provisional application No. 63/185,037, filed on May 6, 2021.

(51) Int. Cl. A01K 5/01

(52) U.S. Cl. CPC A01K 5/0114

(57) ABSTRACT

Described are pet food dishes and methods of using pet food dishes.

### FIELD

The invention is in the field of pet food dishes.

### BACKGROUND

Pet food dishes are available in a large variety of designs. Many are of standard size and shape for a pet dog or cat, and focus on function. Typical designs have a bowl that is defined by a bottom and cylindrical sidewalls, and can be placed on a floor to allow a pet to eat or drink from the bowl. Other designs present a bowl that is elevated above the floor to allow easier use by the pet. Graphic designs around the outside of the sidewall are common.

### SUMMARY

Pet owners enjoy humorous themes for their pets. Commonly, novelty items allow pets to be personified, given a human attribute, or comically shown to exhibit a human behavior.

The present invention relates to pet bowls that are shaped to mimic a drinking vessel of a type used by a human pet owner, but larger, to be used by a pet.

In one aspect, the invention relates to a pet food dish shaped like an enlarged drinking vessel. The dish has: a base having a diameter of at least 5 inches; a height of at least 5 inches; and a bowl. The bowl has volume that is at least 24 ounces and a top opening having a diameter of at least 5 inches.

In another aspect, the invention relates to a method of feeding a pet dog or cat by filling a pet food dish of the present description with food or a drink (e.g., water, milk), placing the dish on a floor, and allowing the pet to eat or drink from the dish.

### BRIEF DESCRIPTION OF THE DRAWINGS

FIGS. 1A and 1B show an example pet food dish as described, with comparable human drinking vessels in the form of wine glasses.

FIGS. 2A and 2B show an example pet food dish as described, with a comparable human drinking vessel in the form of a beer mug.

FIG. 3 shows an example pet food dish as described, in the form of a lowball drink glass, or whiskey glass.

FIGS. 4A and 4B show an example pet food dish in the form of a plastic cup (e.g., a colored plastic picnic cup “red solo cup”), with a comparable human drinking vessel.

FIGS. 5A, 5B, and 5C show an example of a pet food dish in the form of a wine glass.

### DETAILED DESCRIPTION

The following description relates to a dish that is designed for use by a pet, such as a dog or a cat, but that has a design of a drinking vessel that would be used by a human. Example pet food dishes can exhibit a design that mimics a comparable human drinking vessel such as a wine glass, a beer mug, a “lowball” drink glass (a.k.a. a “whiskey glass”), a martini glass, or a plastic cup of a type popularly used at a party for drinking beer dispensed from a keg (a “red solo cup”), but larger in size. A “comparable” human drinking vessel is a vessel that the pet food dish is designed to mimic; herein, several examples are expressly mentioned: a wine glass, a beer mug, a “lowball” drink glass, a martini glass, and plastic “red solo cup.”

In general, a pet dish as described can have look, shape, and a general appearance to mimic a human drinking vessel, but with dimensions on a proportionally larger scale and with certain adaptations that allow for use of the dish to provide food or water to a pet. The dish will have features of a human drinking vessel, but larger dimensions, with some or all of the dimensions having a similar proportionality to that of the human drinking vessel, but generally wider to improve lateral stability of the pet food dish. In addition to larger dimensions of similar optionally similar proportionality, the pet food dish can also include other features that cause the pet food dish to have an appearance of a human drinking vessel, such as decorative structure (e.g., fluting, decorative depressions, a rounded upper lip, grooves or markings) that extends around an outside surface of vertical sidewalls of the pet food dish.

The dish includes a base at a bottom of the dish and a bowl that is supported above the base. The bowl is defined to include a bowl volume that can contain food or water, and that can be accessed by a pet through a top opening to allow the pet to eat or drink the food or water. The bowl should be sized and located as part of the dish at a location that allows the bowl to be easily filled by a pet owner, and that allows for easy access by the pet to the contents (food or water) of the bowl. Optionally, the bowl of the dish can accommodate a removable “dish insert” in the form of a dish that can be placed into and removed from the bowl of the pet food dish.

Compared to a human drinking vessel, the pet food dish of the present description is enlarged, and may also include other optional differences in design (dimensions or proportions of dimensions) to enhance the functionality of the pet food dish for presenting food or water to a pet and allowing the pet to easily consume food or water from the bowl of the pet food dish.

A bowl of the presently-described pet food dish may have a larger volume compared to a volume of a comparable type of a human drinking vessel that is used to contain and deliver a liquid for drinking. A bowl, or a “dish insert” as described, may have a volume of at least 1.5 cups, such as a volume in a range of from 3.5 to 7 cups, e.g., from 3.8 to about 6.5 cups or from about 4 to about 6 cups. On a basis of fluid ounces, the bowl (or dish insert) may have a volume of at least 24 or 28 fluid ounces, such as a volume in a range of from 28 to 56 ounces, e.g., from 35 to 50 ounces.

The bowl may have a top opening that has a diameter that is larger than a comparable type human drinking vessel. A diameter of a top opening of a bowl may be sufficient to allow food or water to be added to the bowl, and also sufficient to allow a pet to consume food or water from the bowl. Examples of useful diameters may be at least 4 inches, e.g., in a range from 5 to 12 inches, e.g., from about 5.5 to about 8 or 10 inches. A dish insert can have a comparable but slightly smaller diameter.

The pet food dish may have a bottom (also referred to as a “base”) that has a diameter that is larger than a comparable type human drinking vessel. A diameter of a bottom of the dish may be sufficient to allow the dish to be stable on a supporting surface, such as a floor. A diameter of a bottom may be larger than a diameter of a top opening of a pet food dish, smaller than, or approximately the same diameter as a top opening of a pet food dish. Examples of useful diameters of a bottom of a pet food dish as described may be at least 4 inches, e.g., in a range from 5 to 14 inches, e.g., from 6 to 8, 10, or 12 inches.

The pet food dish may have any useful height, from a base to an upper opening. Example heights may be at least 5 or 6 inches, e.g., in a range from 5 to 10 inches, such as from 6 to 8 or 6 to 9 inches.

To mimic a human drinking vessel, a pet food dish of this description can have a general form, shape, and look of the human drinking vessel, but with an enlarged size. When enlarged, the different major dimensions of the pet food dish can be enlarged to exhibit proportions that are similar to, or that differ in useful ways, as compared to the proportions of dimensions of a comparable human drinking vessel. To the extent that proportions of dimensions of the pet food dish differ as compared to the comparable human drinking vessel, the difference can be to improve the functionality of the pet food dish for use in providing food or water to a pet.

For an example pet food dish, a ratio of height to width (diameter) may be comparable to a ratio of height to width of a human drinking vessel. Or, to provide increased stability of a dish and to provide a larger top opening relative to height, a pet food dish as described may have a ratio of height width that is smaller than that of a comparable human drinking vessel; the proportion of height to width of the pet food dish may be less than the proportion of height to width of a comparable human drinking vessel. Examples of useful ratios of height to width (height/width) of a pet food dish as described may be in a range of from 0.7 (h/w) to 1.5 (h/w), such as from 0.8 (h/w) to 1.4 (h/w).

Optionally, a bowl of a pet food dish as described may have an “artificial bottom,” meaning a bottom that is located above a natural position of a bottom of the bowl when considering outer surfaces and dimensions of the dish, or that is located above a location of a bottom of a bowl of a comparable human drinking vessel. The artificial bottom may be part of the bowl of the pet food dish, or may be a structure of a dish insert that is removably contained within the bowl of the pet food dish.

To form an artificial bottom of a bowl (not as part of a dish insert), a bottom surface of an interior space of the bowl is raised relative to a “natural bottom” of a bowl, e.g., relative to a base of the dish, or relative to a stem of a wine or martini glass for a wine or martini glass design, or is otherwise placed at a higher location compared to a bottom of a bowl of a comparable human drinking vessel. The artificial bottom causes a depth of the bowl to be reduced compared to a depth that would result from placing the bottom at a location of a comparable human drinking vessel. The artificial bottom can be formed by placing a substantially two-dimensional horizontal bottom surface (which may be flat, partially flat, or partly or slightly curved) of a bowl at a location that is higher than a natural bottom of the bowl (meaning higher than a comparable location of a bottom of a comparable human drinking vessel). The artificial bottom may be formed, for example by increasing a thickness of a base of a pet food dish, or by increasing a thickness of a bottom and sidewalls of a bowl, if the bowl is supported by a vertical stem as with a wine glass or martini glass design. An artificial bottom may be completely flat, or may include a partially flat portion, e.g., may have a horizontally, two-dimensionally flat portion that makes up at least 25, 40, 60, or 80 percent of the area of the bottom. All general and specific volumes of a bowl that are described herein refer to a volume of a bowl above an artificial bottom (if present), within bowl sidewalls, and up to an upper opening at a top location pf the bowl.

The artificial bottom reduces the depth of the interior of the bowl to place the bottom at a location that is closer to the top opening of the bowl. An artificial bottom is useful to allow a pet to more easily access the entire interior space of the bowl, including the bottom surface of the bowl, through the top opening, especially if a natural bottom of the bowl is too far below the top opening to allow for convenient access of the entire bowl interior by at pet.

In example pet food dishes, a bottom of a bowl, whether an artificial bottom or a natural bottom of a bowl, can be located at a level below the top opening of the bowl that will allow a pet, such as a dog or a cat, to consume water or food from the entire volume of the bowl, including from the bottom surface of the bowl. Measured as a distance of the bottom surface of the bowl below the top opening, a bottom of a bowl may be not more than 6 inches below the top opening, e.g., from 2 to 6 inches, or from 4 to 5 inches below the top opening of the bowl. Measured as a distance between the bottom surface of the bowl and the bottom of the pet food dish, at the dish base, which may rest on a floor during use of the dish, a bottom surface of a bowl may be at least 2, 3, 4, or 5 inches from the bottom of the pet food dish, e.g., in a range from 3 to 6 inches from the bottom of the pet food dish.

Additional features of a pet food dish can be included, which further depart from features of drinking vessels that are adapted for use by humans. In addition to features previously described, another optional feature of a pet food dish can be a weight at a bottom portion of the pet food dish that adds stability and mass to the pet food dish to help prevent the dish from moving along a floor surface during use, or tipping. A weight may be located at a bottom half or bottom portion of a dish, e.g., within a base of a dish. The weight may have a density that is greater than plastic, e.g., density that is greater than 1.5, 2 3, 4, or 5 grams per cubic centimeter.

A useful or preferred weight may be made of sand (density of approximately 1.5 or 1.6 grams per cubic centimeter), metal, a dense composite or aggregate material (e.g., concrete, ceramic, cement), or another material that has a density of at least 1.5 grams per cubic centimeter, or greater. A weigh can be of any effective size and shape, e.g., a concrete, cement, or ceramic plate, disk, or “puck”-shaped article that is secured to the base of the pet food dish, or a hollow opening within the base that is filled with sand or concrete.

The mass (in ounces) of the weigh may be as desired, for example in a ranger from 6 to 26 ounces, or from 8 to 20 ounces, located at a bottom third of the pet food dish.

Optionally, additionally, or alternately, a pet food dish can include a frictional grip at the bottom surface of the dish, such as a frictional surface that adds stability to the pet food dish and helps prevent the dish from moving along a floor surface during use. The frictional surface may be a flat or textured rubber surface that is adhered to a bottom surface of a base of a pet food dish, and that contacts a floor surface when the pet food dish is place on a floor.

Example frictional surfaces may be non-plastic, e.g., rubber surfaces e.g., of natural or synthetic rubber or elastomer (different from a plastic material used for the dish base) and that may either be substantially smooth or textured (e.g., with ridges, grooves, bumps, diamonds or pyramids) to produce an increased static or sliding coefficient of friction of the base surface relative to a flooring material such as a vinyl, wood, tile floor (compared to the coefficient of friction of the base material (which may be made of plastic or glass) in the absence of the frictional surface).

In an example pet food dish, a frictional surface made of smooth or textured elastomeric rubber secured to the bottom of the base will increase a coefficient of friction (e.g., static) of the pet food dish in contact with a vinyl, wood, or tile flooring material by at least 5 or 10 percent, relative to a coefficient of friction of the same pet food dish, having a plastic base material, without the frictional surface.

A pet food dish may also include a hollow interior, e.g., beneath an artificial bottom (as described) that may contain room for a dog treat. In this example, the bowl at the upper portion of the pet food dish may contain an removable dish insert that includes a bottom, which is an “artificial bottom.”

A pet food dish may also include an electrical pump for circulating a liquid such as water or milk, and may also include an electrical cooling device to keep the temperature of the liquid at a temperature below room temperature.

A pet food dish may include other electrical features such as lights.

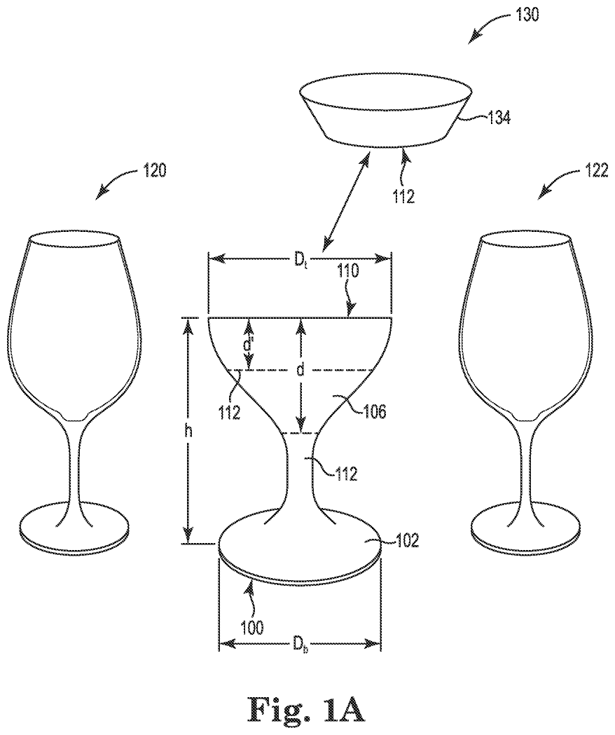

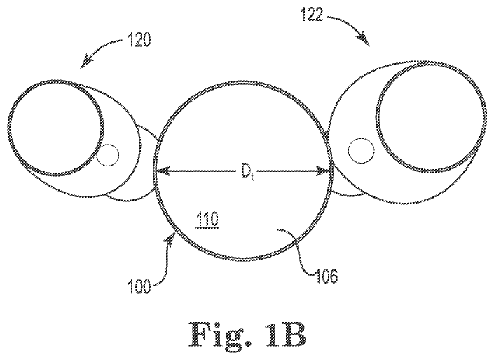

Referring to FIGS. 1A and 1B, illustrated is a pet food dish 100 (center) in the form of a wine glass, arranged next to two comparable (wine glass) human drinking vessels, 120 and 122. Pet food dish 100, which has a design to mimic a (comparable) human drinking vessel in the form of a wine glass, includes base 102, bowl 106, and vertical stem 104 that connects the bottom (lower end) of bowl 106 to base 102.

As shown, pet food dish 100 has a design that mimics the design of wine glasses 120 and 122, including comparable components such as base 102, stem 104, bowl 106, and top opening 110, each of which corresponds to a structure of wine glasses 120 and 122. Top opening 110 has a diameter Dₜ. Base 102 has a diameter D_{b}. Compared to wine glasses 120 and 122, dish 100 has a wider base 102, wider top opening 110, and a smaller ratio of height (h) to width (Dₜ or D_{b})

A dish 100 may have a bowl that has a depth (d) that extends from top opening 110 to an interior bottom surface of bowl 106, approximately at a location at which the bottom of bowl 106 meets the top of stem 104 (the “natural bottom”). This depth of bowl 106 provides for a maximum volume of the interior of bowl 106.

Optionally, but not as a requirement, a dish 100 may instead include an “artificial bottom,” meaning a bottom that does not extend to a depth that the overall structure of the bowl would allow, but is raised above a lower location that could otherwise serve as a bottom of the inside of bowl 106. FIG. 1A shows optional artificial bottom of bowl 106, indicated by dashed line 112. Artificial bottom 112 is located a distance d′ below top opening 110, and a distance above the otherwise natural bottom of bowl 106 (indicated approximately by the dashed line at the top of stem 104 and the bottom of bowl 106) that would follow the curved bottom or sidewall portion of the bowl down to the top of stem 104. The distance d′ between top opening 110 and artificial bottom 112 may be a distance that raises a top surface of bottom 112 to a location between the top opening and the bottom of the bowl that allows a pet to access the surface of bottom 112 through top opening 110 to consume food or water from bottom 112 of bowl 106.

Optionally, artificial bottom 112 may be removable as part of a removable dish insert 130 is sized to rest within bowl 106 and top opening 110. The space below artificial bottom 112 of a removable dish insert contained in bowl 106 and the natural bottom of bowl 106 may be empty, and may be useful as storage space for a dog treat. As shown at FIG. 1A, removable dish insert 130 includes bottom 112 and sides 134, and can fit into the top of bowl 106 through opening 110.

While FIG. 1A shows a dish that mimics a human wine glass, the dish may instead mimic a human martini glass having comparable height and width dimensions and ratios. In a version of dish 100 that mimics a martini glass, the sidewalls of bowl 106 will be relatively more straight along an angle between the upper end of stem 104 and opening 110, compared to the somewhat curved sidewalls of the illustrated wine glass version of bowl 106.

Example dimensions of a pet food dish that mimics a wine glass or a martini glass may include the following:

An example total volume of the bowl of an example wine glass or martini glass may be a volume of at least 3, 3.5, or 4 cups, such as a volume in a range of from 4 to 6 cups, e.g., from 4.5 to 5.5 cups.

An example height of dish 100 may be at least 5, 6, or 7 inches, e.g., from 6 to 9 inches.

An example diameter Dₜ of top opening 110 of dish 100 may be at least 5 inches, e.g., from 5 to 9 inches, e.g., from 6 to 7 or 8 inches.

An example diameter D_{b} of base 102 of dish 100 may be at least 4 inches, e.g., from 5 to 8 inches, e.g., from 5 to 7 inches.

The height of dish 100 may be approximately equal to the width, or, in some examples, may be slightly less then or somewhat greater than the width of dish 100 at the upper diameter.

An example ratio of height (h) to diameter (either D_{b} or Dₜ) of dish 100 (height/diameter, or height/width), with a height or diameter generally or particularly specified herein, may be in a range of from 0.9 to 1.4, such as from 1.0 to 1.3 or from 1.0 to 1.2, although other ratios may also be useful. The ratio of height to diameter is smaller than a typical wine glass (see FIG. 1A.)

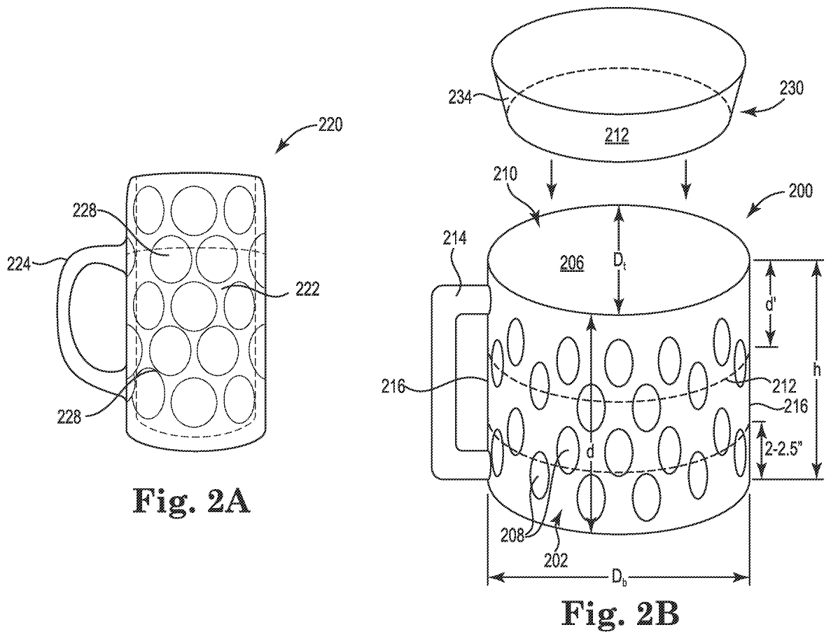

Referring to FIGS. 2A and 2B, FIG. 2A shows a human drinking vessel in the form of beer mug 220 having bowl interior 222, handle 224, and an outside surface that includes a non-random pattern of decorative round (e.g., circular or oval), smooth depressions or “thumbprints.” FIG. 2B shows pet food dish 200, which has a design to mimic a (comparable) human drinking vessel in the form of beer mug 220, includes base 202 and bowl 206 defined by vertical sidewalls 216 extending directly vertically from an outer perimeter of base 202. Sidewalls 216 extend vertically, or substantially vertically (within 10 or 5 degrees of vertical), without interruptions, over the entire height and circumference of dish 200.

As shown, pet food dish 200 has a design that mimics the design of beer mug 220, including comparable components such as base 202, bowl 206, top opening 210, handle 214, and a non-random pattern of decorative depressions 208, each of which corresponds to a structure of beer mug 220. Top opening 210 has a diameter Dₜ. Base 202 has a diameter D_{b}, which is substantially equal to diameter Dₜ at top opening 210. Compared to beer mug 220, dish 200 has a wider base 202, wider top opening 210, and a smaller ratio of height (h) to width (Dₜ or D_{b}).

A dish 200 may have a bowl interior that has a depth that extends from top opening 210 to a bottom of bowl 206, approximately at a location at which the bottom of bowl 206 reaches base 202. For example, a bottom surface of bowl 206 may be located within ½ inch or 1 inch from the bottom of dish 200, and the bottom of base 202. This depth of bowl 206 provides for a relatively large or a maximum volume of the interior of bowl 206.

Optionally, but not as a requirement, a dish 200 may include an “artificial bottom,” meaning a bottom that does not extend to a depth that the overall structure of the dish would allow, but is raised from a lower position that might otherwise serve as a bottom to a higher position. Bowl 206 of FIG. 2B has an artificial bottom as indicated by dashed line 212, located a distance d′ below top opening 210, and a distance above the otherwise natural bottom of bowl 206 that would follow the flat bottom surface of the bowl at a location that is closer to base 202 and the bottom of dish 200. The distance d′ between top opening 210 and artificial bottom 212 may be a distance that raises a surface of bottom 212 to a location between top opening 210 and the bottom (base 202) that allows a pet to access the surface of bottom 212 through top opening 210 to consume food or water from bottom 212 of bowl 206.

Optionally, artificial bottom 212 may be removable as part of a dish insert that fits within bowl 206, and the space below artificial bottom 212 and the natural bottom of bowl 206 may be empty, and may be useful as storage space for a dog treat.

Optionally, artificial bottom 212 may be removable as part of a removable dish insert 230 that rests within bowl 206. The space below artificial bottom 212 of a removable dish insert contained in bowl 206 and the natural bottom of bowl 206 may be empty, and may be useful as storage space for a dog treat. As shown at FIG. 2B, removable dish insert 230 includes bottom 212, and sides 234, and can fit into the top of bowl 206 through opening 210.

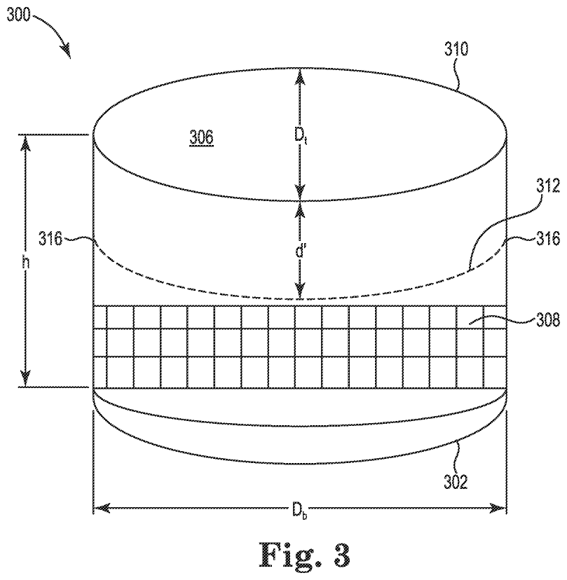

Referring to FIG. 3, another example of a pet food dish 300 has a design that mimics a “lowball” or a “whiskey” glass. Pet food dish 300 includes base 302 and bowl 306 defined by vertical sidewalls 316 extending directly vertically up from the perimeter of base 302. Sidewalls 316 extend vertically, or substantially vertically (within 20, 15, 10, or 5 degrees of vertical), without interruptions, over the entire height and circumference of dish 300.

As shown, pet food dish 300 has a design that mimics the design of a whiskey glass, including comparable components such as base 302, bowl 306, top opening 310, and decorative engraving or grooves 308 that surround the outside circumference of vertical sidewalls 316. Top opening 310 has a diameter Dₜ. Base 302 has a diameter D_{b}, which is substantially equal to diameter Dₜ at top opening 310. Compared to a human lowball glass, dish 300 has a wider base 302, wider top opening 310, and a smaller ratio of height (h) to width (Dₜ or D_{b}).

A dish 300 may have a bowl that has a depth that extends from top opening 310 to a bottom of bowl 306, approximately at a location at which the bottom of bowl 306 reaches base 302. For example, a bottom surface of bowl 306 may be located within 0.5 inch, 1 inch, or 1.5 inches from the bottom of dish 300, and the bottom of base 302. This depth of bowl 306 provides for a relatively large or a maximum volume of the interior of bowl 306.

Optionally, but not as a requirement, a dish 300 may include an “artificial bottom,” meaning a bottom that does not extend to a depth that the overall structure of the bowl would allow, but is raised from a position of a lower potential bottom of the bowl that would result in a larger total volume of the bowl. Bowl 300 as illustrated may have an artificial bottom as indicated by dashed line 312, located a distance d′ below top opening 310, and a distance above an lower potential location for a bottom of bowl 306 that would follow the flat bottom portion of the bowl at a location that is closer to base 302 and the bottom of dish 300. The distance d′ between top opening 310 and artificial bottom 312 may be a distance that raises bottom 312 to a location between top opening 310 and the bottom (base 302) of bowl 306, that allows a pet to access the surface of bottom 312 through top opening 310 to consume food or water from bottom 312 of bowl 306.

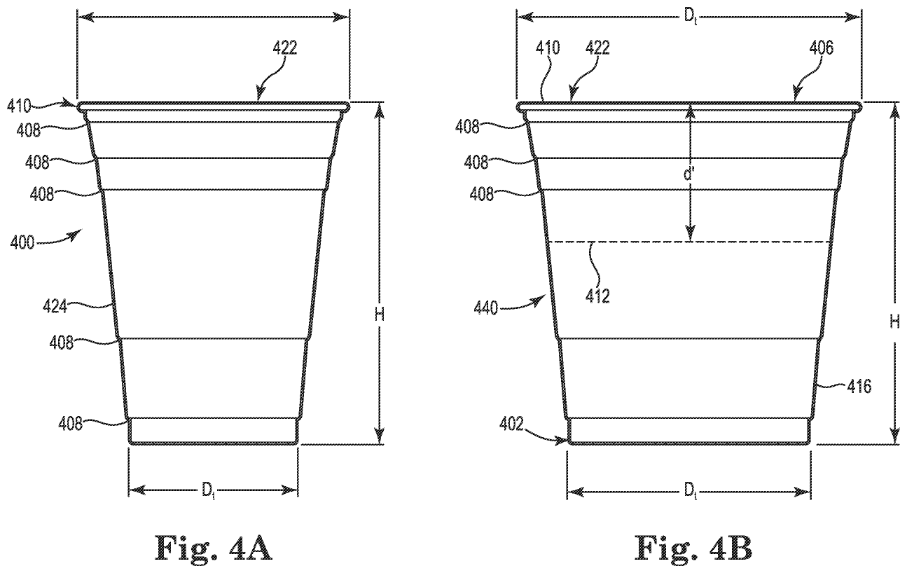

Referring to FIGS. 4A and 4B, FIG. 4A shows a human drinking vessel in the form of a plastic party cup, or a “red solo cup,” or SOLO® PLASTIC PARTY CUP sold by the SOLO® Cup Company. The human version has a width of approximately 92 millimeters at a top opening, a width of approximately 57 millimeter at a bottom (base), and a height of approximately 117 millimeters, with an interior volume of approximately 18 ounces. Cup 400 includes interior 422, sidewall 424, and an outside surface of the sidewall that includes multiple decorative circumferential (horizontal) lines 408, each of which extends horizontally to create a reduction in the diameter of the sidewall. Cup 400 also includes a rounded (circular-radius) top lip 410 at upper opening 410.

FIG. 4B shows pet food dish 440, which has a design to mimic a (comparable) human drinking vessel (plastic cup) 400. Dish 440 includes base 402, and interior space (bowl) 406 defined by vertical sidewalls 416 extending in a vertically-slanted direction from an outer perimeter of base 402. Sidewalls 416 extend substantially vertically (within 20, 15, 10, or 5 degrees of vertical), over the height and circumference of dish 440.

As shown, pet food dish 440 has a design that mimics the design of plastic cup 400, including comparable components such as base 402, bowl 406, top opening 422, and decorative lines 408, each of which corresponds to a structure of cup 400 of FIG. 4A.

Top opening 410 has a diameter Dₜ. Base 42 has a diameter D_{b}, which is less than diameter Dₜ at top opening 410. Compared to cup 400, pet food dish 440 has a wider base 402, wider top opening 410, and a smaller ratio of height (h) to width (Dₜ or D_{b}).

A dish 440 may have a bowl interior that has a depth that extends from top opening 410 to a bottom of bowl 406, approximately at a location at which the bottom of bowl 406 reaches base 402. For example, a bottom surface of bowl 406 may be located within ½ inch or 1 inch from the bottom of dish 440, and the bottom of base 402. This depth of bowl 406 provides for a relatively large or a maximum volume of the interior of bowl 406.

Optionally, but not as a requirement, a dish 440 may include an “artificial bottom,” meaning a bottom that does not extend to a depth that the overall structure of the dish would allow, but is raised from a lower position that might otherwise serve as a bottom to a higher position. Bowl 440 of FIG. 4B has an optional artificial bottom as indicated by dashed line 412, located a distance d′ below top opening 410, and a distance above the otherwise natural bottom of bowl 406 that would follow the flat bottom surface of the bowl at a location that is closer to base 402 and the bottom of dish 440. The distance d′ between top opening 410 and artificial bottom 412 may be a distance that raises a surface of bottom 412 to a location between top opening 410 and the bottom (base 402) that allows a pet to access the surface of bottom 412 through top opening 410 to consume food or water from bottom 412 of bowl 440.

An example total volume of a bowl of a dish 200, 300, or 440, may be at least 30 ounces, such as a volume in a range of from 32 to 50 ounces, e.g., from 32 to 45 ounces.

An example height of dish 200, 300, or 440 may be from 4 to 9 inches, e.g., from 5 to 8 inches.

Example diameters Dₜ and D_{b} of dish 200, 300, or 440 may be 5 to 8 inches, e.g., from 5.5 to 7 inches. For dish 440, the top diameter Dₜ may be larger than the bottom diameter D_{b}, to cause the sidewalls to extend vertically at a slight angle, as illustrated.

An example ratio (height/diameter) of height (h) to diameter (either D_{b} or Dₜ) of dish 200, 300, or 440 (height/diameter, or height/width), with a height or diameter generally or particularly specified herein, may be in a range of from 0.7 (h/w) to 1.3 (h/w), such as from 0.8 (h/w) to 1.2 (h/w).

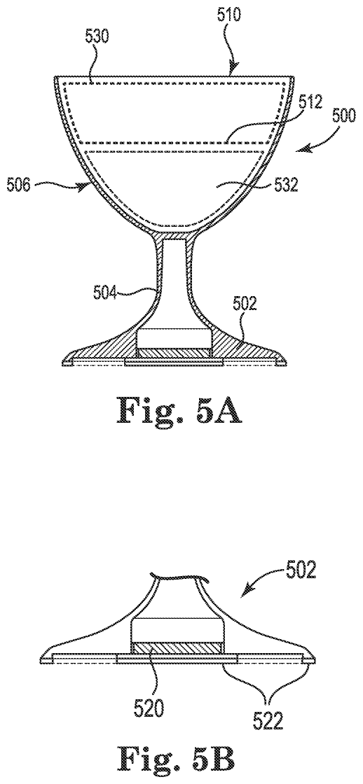

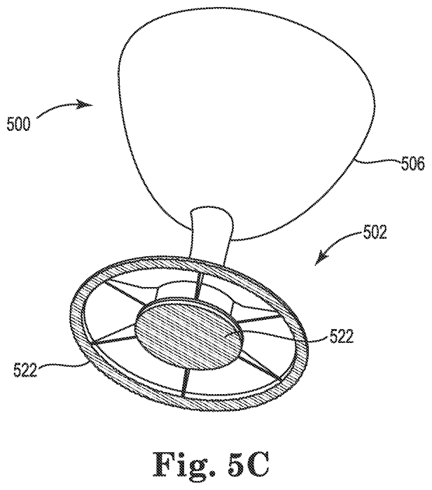

Consistent with the foregoing, an additional example pet food dish is shown at FIGS. 5A, 5B, and 5C. As shown, pet food dish 500 has a design that mimics the design of a wine glass, including comparable components such as base 502, stem 504, bowl 506, and top opening 510, with dimensions of these features being consistent with a pet food dish of the present description. Removable dish insert is 530 is shown as being present at the upper portion of bowl 506. A lower portion of bowl 506, above a natural bottom and below the artificial bottom 512 of dish insert 530, is a hollow space. As an added feature, pet food dish 500 includes a weight 520 as part of base 502, and a rubber grip 522 on the bottom surface of base 502. As illustrated, weigh 520 may be a piece of metal, concrete, cement, or sand contained within a hollow space of base 502.

A pet food dish as described can be useful to provide food or a drink to a pet. According to a method of feeding a pet dog or cat, a food or drink (e.g., water or milk) can be placed into a bowl portion of the dish, and the dish can be place on a floor to allow the pet to eat or drink from the dish.

1. A pet food dish shaped like an enlarged drinking vessel, the dish comprising:
a base having a diameter of at least 5 inches,
a height of at least 5 inches, and
a bowl having:
a volume that is at least 24 ounces,
a top opening having a diameter of at least 5 inches.

2. A dish of claim 1, the bowl having a removable artificial bottom.

3. A dish of claim 1, the bowl having a volume of at least 30 ounces.

4. A dish of claim 1, the dish having a shape that mimics a human drinking vessel selected from a wine glass, a martini glass, a beer mug, a plastic party cup, and a lowball drink glass.

5. A dish of claim 1 in the form of a wine glass comprising a bowl, a stem, a base, the bowl having a substantially flat interior bottom.

6. A dish of claim 1 having a ratio of height to width (height/width) in a range from 0.8 to 1.5.

7. A dish of claim 1 having a form of an enlarged lowball-style drinking glass, comprising:
the base,
sidewalls that extend substantially vertically upward from the base to the top opening, and
the bowl, comprising:
a bottom that extends horizontally at a location that is at least 2 inches above the bottom of the dish.

8. A dish of claim 7 having:
a height in a range from 5 to 10 inches,
a top opening having a diameter in a range of from 5 to 10 inches, and
a base having a diameter in a range of from 5 to 10 inches.

9. A dish of claim 7 having a height over width (height/width) in a range from 0.9 to 1.1.

10. A dish of claim 1 having a form of an enlarged beer mug, comprising:
the base,
sidewalls that extend upward from the base to the top opening, and
a handle attached to an exterior of the sidewalls,
the bowl, comprising:
a bottom that extends horizontally at a location that is at least 2 inches above the bottom of the dish.

11. A dish of claim 10 having:
a height in a range from 5 to 10 inches,
a top opening having a diameter in a range of from 5 to 10 inches, and
a base having a diameter in a range of from 5 to 10 inches.

12. A dish of claim 1 having a form of an enlarged wine glass or martini glass, comprising:
the base,
a stem extending from the base to a bowl,
sidewalls that extend upward from the stem to the top opening, and
the bowl, comprising horizontal artificial bottom.

13. A dish of claim 1 having a form of an enlarged plastic party cup, comprising:
the base,
sidewalls that extend upward from the base to the top opening, and
the bowl, comprising:
a bottom that extends horizontally at a location that is at least 2 inches above the bottom of the dish.

14. The dish of claim 13, the sidewalls extending upward at an angle in a range from 5 to 20 degrees from vertical.

15. A pet food dish having a form of an enlarged wine glass or an enlarged martini glass, the dish having:
a height of at least 6 inches,
a base having a diameter of at least 5 inches,
a vertical stem connecting the base to a bowl,
the bowl having a top opening having a diameter of at least 5 inches.

16. A dish of claim 15 having a height over width (height/width) in a range from 0.8 to 1.5.

17. A dish of claim 1 having a weight in the base, the weight having a density of at least 1.5 grams per cubic centimeter.

18. A dish of claim 1 having a frictional surface at the bottom.

19. A method of feeding a pet, the method comprising:
in a pet food dish shaped like an enlarged drinking vessel, the dish comprising:
a base having a diameter of at least 5 inches,
a height of at least 5 inches, and
a bowl having:
a volume that is at least 24 ounces,
a top opening having a diameter of at least 5 inches,
placing the dish on a floor surface, and
placing food or water in the bowl.
